(19) United States
(12) Patent Application Publication
(10) Pub. No.: US 2008/0001692 A1
(43) Pub. Date: Jan. 3, 2008

(54) Electromagnet Core and Method of Manufacturing the Same

(75) Inventors: Masahisa Miyahara, Niigata-shi (JP); Koichiro Morimoto, Niigata-shi (JP)

Correspondence Address: DARBY & DARBY P.C., P.O. BOX 770, Church Street Station, New York, NY, 10008-0770, US

(73) Assignee: Mitsubishi Materials PMG Corporation, Niigata-shi, Niigata (JP)

(21) Appl. No.: 10/595,681

(22) PCT Filed: Oct. 28, 2004
(86) PCT No.: PCT/JP04/15985

§ 371 Date: Jun. 22, 2007

(30) Foreign Application Priority Data
Nov. 5, 2003 (JP) 2003-375194

(51) Int. Cl. H01F 1/00; B22F 1/00; B22F 3/04; F02M 51/00

(52) U.S. Cl. 335/297; 239/585.1; 419/65

(57) ABSTRACT

To improve chemical resistance and heat resistance of an electromagnet core used for a liquid fuel injector. A core is formed by using a binder for a soft magnetic powder, wherein the binder is made of a polyimide resin having a molecular structure having a thermal and chemical stability. A volume ratio of the binder made of the polyimide resin to the soft magnetic powder is in a range of from 0.05 wt % to 1.0 wt %. Since the heat resistance and the chemical resistance of the core can be improved, the core can be used for a valve control electromagnet used for a liquid fuel injector and effectively operated when the core is attached to an engine.

### CROSS REFERENCE TO PRIOR RELATED APPLICATIONS

This application is a U.S. national phase application under 35 U.S.C. § 371 of International Patent Application No. PCT/JP2004/015985, filed Oct. 28, 2004, and claims the benefit of Japanese Patent Application No. 2003-375194, filed Nov. 5, 2003, both of which are incorporated by reference herein. The International Application was published in Japanese on May 19, 2005 as International Publication No. WO 2005/045857 A1 under PCT Article 21(2).

### TECHNICAL FIELD

The present invention relates to an electromagnet core used for a liquid fuel injector and a method of manufacturing the electromagnet core.

### BACKGROUND ART

Conventionally, an electromagnet core made of a powder composite material has been proposed. For example, there has been proposed a measuring valve control electromagnet used for a liquid fuel injector. The electromagnet includes a fixing core made of a magnetic material, an excitation core, and a valve activating armature. The fixing core is formed by pressing a mixture of a powder iron material and an epoxy binder. After the core is formed, the core is subjected to a calcination process. The powder iron material is made of ferrite. The epoxy binder is selected from various types of epoxy resins. Generally epoxy resin of from 2 wt % to 50 wt % is contained in the mixture.

In addition, an iron power grain is covered with a thin phosphate layer (insulating film) having an electrical insulating property. In addition, as an example, there has been proposed an iron powder grain containing a polymer additive (for example, polyimide or phenol resin) of 0.5 wt %.

The epoxy binder or the polymer additive has an electrical insulating function and binds the grains. Due to high electric resistance between the powder grains, eddy current is not generated at the associated locations. (See Japanese Unexamined Patent Application Publication No. H7-310621 and PCT Japanese Translation Patent Publication No. 2000-501570.)

### DISCLOSURE OF THE INVENTION

Problems to be Solved by the Invention

Since a liquid fuel injector with an electromagnet is usually disposed on the pathway of liquid fuel supply, an electromagnet core which is integrally installed in the liquid fuel injector may come in direct contact with liquid fuel or in contact with vaporized gas of the liquid fuel. For this reason, chemical resistance is required for the electromagnet core. On the other hand, the liquid fuel injector with the electromagnet core is integrally attached to an engine. Therefore, the electromagnet is exposed to high temperatures, so that heat resistance is required for the electromagnet core as well.

The electromagnet core is formed by performing a pressing process on a mixture of a raw powder made of a soft magnetic material and a binder. As the volume ratio of the raw powder is made higher, performance of the electromagnet such as magnetic permeability of magnetic flux density is improved.

However, in the aforementioned conventional technique, since the binder for the raw powder is an epoxy resin, a polyimide resin, or a phenol resin having a heat resistance of from 50 to 160° C., there is a problem in that the chemical resistance or the heat resistance of the electromagnet core is low. Therefore, the conventionally proposed electromagnet core has a limitation for use as the measuring valve control electromagnet used in a liquid fuel injector.

In a method of manufacturing an electromagnet core, a flow initiating material is mixed into the mixture of raw powder and binder in order to increase the flowing property thereof in a pressing process. However, the flow initiating material has a limitation in increasing the flowing property. As a result, the volume ratio of the raw powder in the electromagnet core must be further increased.

In order to solve the aforementioned problems, an object of the present invention is to improve chemical resistance and heat resistance of an electromagnet core used for a liquid fuel injector. In addition, another object of the present invention is to increase the volume ratio of raw powder portion by improving the flowing property of a mixture of a raw powder and a binder in manufacturing an electromagnet core used for a liquid fuel injector which is formed by performing a pressing process on the mixture of the raw powder made of a soft magnetic material and the binder.

According to an aspect of the present invention, there is provided an electromagnet core made of a soft magnetic material and capable of accommodating a coil, wherein the electromagnet core is formed with a soft magnetic powder and a binder for the soft magnetic powder, and the binder is made of a polyimide resin.

According to another aspect of the present invention, in the electromagnet core according to the aspect above, the ratio of the polyimide resin to the soft magnetic powder is in a range of from 0.05 wt % to 1.0 wt %.

According to another aspect of the present invention, in the electromagnet core according to the above aspect, the electromagnet core is used for a measuring valve control electromagnet used for a liquid fuel injector.

According to another aspect of the present invention, there is provided a method of manufacturing an electromagnet core made of a soft magnetic material and capable of accommodating a coil, by inserting a mixture of soft magnetic powder and a binder made of a polyimide resin into a molding die and molding the mixture by using a pressing process, wherein a lubricant layer is formed on a surface of a receiving portion of the molding die for receiving the mixture.

According to another aspect of the present invention, in the electromagnet core according to the aspect just described, the receiving portion is heated from room temperature to a high temperature, and before the mixture is inserted, the surface of the receiving portion is coated with a lubricant solution, and moisture in the coated lubricant solution is vaporized by the heat of the receiving portion, thereby forming the lubricant layer.

According to another aspect of the present invention, in the electromagnet core according to the aspect just described, a flow initiating material is added to the mixture.

### EFFECTS OF THE INVENTION

According to one aspect of the present invention, the polyimide resin having a thermally and chemically stabilized molecular structure is used for the binder for the soft magnetic powder, so that it is possible to improve the heat resistance and the chemical resistance in comparison with a conventional core.

According to another aspect of the present invention, the ratio of the polyimide to the soft magnetic powder is in a range of from 0.05 wt % to 1.0 wt %, so that the molding can be effectively performed, and a desirable volume ratio of the soft magnetic powder in the core can be secured.

According to another aspect of the present invention, since the electromagnet core having an improved heat resistance and chemical resistance is used as a valve control electromagnet of the liquid fuel injector, the injector attached to an engine can be effectively operated.

According to another aspect of the present invention, since the lubricant layer formed on surfaces of the receiving portion of the molding die imparts or improves the lubricating property between the soft magnetic powder and the surfaces, friction between the soft magnetic powder and the surfaces caused by the press pressure at the molding process can be reduced. As a result, gaps between the grains of the soft magnetic powder and between the soft magnetic powder and the binder can be reduced at the molding process.

According to another aspect of the present invention, the lubricant layer above is formed by vaporizing the moisture of the lubricant solution by using the heat of the receiving portion, so that the thickness of the lubricant layer can be reduced. As a result, the molding can be performed with improved accuracy.

According to another aspect of the present invention, the flow initiating material is added, so that the flowing property of the mixture at the pressing process or the like can be further improved. As a result, the density of the core can be further increased.

### BEST MODE FOR CARRYING OUT THE INVENTION

Now, preferred embodiments of the present invention will be described. The scope and spirit of the present invention disclosed in the claims is not limited to the embodiments described herein. Furthermore, any of the components described herein is not intended to be an essential component of the present invention.

FIGS. 1 to 5 show an embodiment of the present invention. An electromagnet 1 includes a core 2 and an excitation coil 3 (see FIG. 1). The core 2 has a shape of a cylinder in which a through hole 4 is formed along an axis z. A circular groove 5 is formed on one side of the core 2 with the center thereof aligned with the axis z. The cylindrical coil 3 is inserted into the groove 5 in a concentric manner. A plunger 6 which is a moving member is disposed along the axis z. An armature 6a made of magnetite or the like and having a shape substantially of a disk is disposed on a distal end of the plunger 6, so that the armature can detachably contact one side surface of the coil 3 and one side surface of the core 2. When a current is applied to the coil 3, the electromagnet is excited, so that the plunger 6 is moved in the direction of the axis z. Referring to FIG. 5, when the current is applied to the coil 3, the armature 6a is suctioned into the electromagnet 1.

The electromagnet 1 is disposed in an injector of a liquid fuel spray apparatus for an engine. As shown in FIG. 5, the injector 7 includes a valve body 9 which has a liquid fuel spray hole 8 at a distal end thereof, a valve seat 10 which is formed in an inner end portion of the liquid fuel spray hole 8, and a needle-shaped valve 11 which is disposed in the valve body 9. In addition, the injector 7 includes an electromagnet 1 which drives the plunger 6 connected to the needle-shaped valve 11 for opening/closing the liquid fuel spray hole 8 and a return spring (not shown) for pressing the armature 6a and the plunger 6 so as to sustain the needle-shaped valve 11 in a closed state thereof. In addition, a liquid fuel supply hole 13 is disposed at the other side of the valve body 9. The liquid fuel supply hole 13 is connected to a liquid fuel pump (not shown). A liquid fuel F is supplied form the liquid fuel pump with a predetermined pressure thereof. In the injector 7, when the coil 3 is applied with a driving voltage and an excitation current, the armature 6a and the plunger 6 are suctioned onto the excitation coil 3, so that the needle-shaped valve 11 allows the liquid fuel spray hole 8 to open. The needle-shaped valve 11 is maintained in the opened state until the magnetic field of the electromagnet 1 is removed. When the liquid fuel spray hole 8 opens, the liquid fuel is sprayed.

The core 2 is formed by integrally fixing a soft magnetic powder 14 with a binder 15 (see FIG. 2). The soft magnetic powder 14 is made of an electromagnetic soft iron or a silicon steel which is relatively easy to magnetize or demagnetize. An insulating film 16 which magnetic force lines may penetrate is formed on a surface of the soft magnetic powder 14. The binder 15 is made of a polyimide resin, that is, a polymer having a molecular structure wherein thermally and chemically stabilized imide rings (heterocyclic rings) or aromatic rings are disposed within a main chain thereof. A grain size (maximum diameter) of the soft magnetic powder 14 is in a range of from 10 μm to 200 μm, and more preferably, from 10 μm to 100 μm. This is because, if the grain size (maximum diameter) of the soft magnetic powder 14 is less than 10 μm, the manufacturing thereof is difficult, and if the grain size (maximum diameter) is more than 200 μm, sufficient resistivity cannot be obtained, and furthermore, sufficient strength cannot be obtained.

The polyimide resin is made of a wholly aromatic polyimide, a bismaleide polyimide, or an additive-type polyimide. The amount added thereof in relation to the soft magnetic powder 14 is in a range of from 0.05 wt % to 1.0 wt %, and more preferably, from 0.1 wt % to 0.5 wt %. This is because, if the polyimide resin is less than 0.05 wt %, desirable resistivity cannot be achieved, and if the polyimide resin is more than 1.0 wt %, the density of the electromagnet core 2 cannot be easily increased, with the result that the magnetic flux density and the permeability deteriorate.

In addition, a flow initiating material 17 described later is mixed into the binder 15.

Now, a method of manufacturing the core 2 is described (see FIG. 3). The molding die 18 includes: a female die 20 in which a through hole 19 is formed; an upper punch 21, that is, a male die which is inserted into the through hole 19 in the downward direction thereof; and a cylindrical core pin 22 and first to third ring-shaped lower punches 23, 24, and 25 which are inserted into the through hole 19 in the upward direction thereof. The core pin 22 is disposed along an axis z′ of the through hole 19, and an upper plane thereof is substantially aligned with an upper plane of the female die 20. The first lower punch 23 is disposed outside the core pin 22 in a concentric manner, and an upper plane 23a thereof constitutes a bottom surface thereof. The second lower punch 24 is disposed outside the first lower punch 23 in a concentric manner, and an upper plane 24a thereof is disposed to be higher than the upper plane 23a in order to form the groove 5 in FIG. 1. The third lower punch 25 is disposed outside the second lower punch 24 in a concentric manner, and an upper plane 25a thereof also constitutes the bottom surface similar to the upper plane 23a. On the other hand, a support hole 26 which the upper plane 22a of the core pin 22 is inserted into is formed through a lower surface of the upper punch 21 along the axis z′. In addition, a heater 27, that is, heating means for maintaining the female die 20 at a predetermined temperature higher than room temperature, for example, at 120° C., is provided within the female die 20.

In the manufacturing process, the core pin 22 and the first to third lower punches 23, 24, and 25 are inserted into the through hole 19 in advance, and a lubricant layer 29 is formed on a wall surface of the through hole 19 and a wall surface of the receiving portion 28 for receiving a raw material, that is, surfaces of the upper planes 23a, 24a, and 25a and inner and outer surfaces of the lower punch 24. More specifically, an aqueous lubricant solution 29a is sprayed from a spray hole 30 which is disposed above the upper plane of the female die 20 and in the vicinity of the through hole 19 so as to coat the wall surface and surfaces of the receiving portion 28. Next, moisture of the coated lubricant solution 29a is vaporized by using the heat of the female die 20, so that the lubricant layer 29 is formed on the wall surface of the through hole 19, the surfaces of the upper planes 23a, 24a, and 25a, and the inner and outer surfaces of the second lower punch 24. As a lubricant solution, an aqueous solution of 1% sodium benzoate or an aqueous solution of 1% potassium dihydrogen phosphate may be used. The solution is sprayed and coated on the wall surface which is heated at 120° C. and vaporized, so that the lubricant layer is formed as a deposited layer on the wall surface

In the state that the lubricant layer 29 is formed on the wall surface of the receiving portion 28 and the like, a mixture of the soft magnetic powder 14 on which the insulating film 16 is formed, the binder (for example, 0.2 wt % additive-type polyimide resin), and the flow initiating material (for example, 0.01 wt % ethylene bis-stearamide) is dropped and received into the receiving portion 28.

As a flow initiating material, a single bisamide wax substance such as ethylene bis-stearamide, ethylene bis-laurylamide, or methylene bis-stearamide, or a mixture thereof is preferably used. This is because, the wax just described has a high melting point of 140° C. or more, while the monoamide material thereof has a low melting point, in which case the flowing property thereof is lowered due to the softening thereof by heat during the warm molding process. In addition, as a flow initiating material, a material formed by adding 30% or less lithium stearate or 12-hydroxy lithium stearate to the wax mentioned above (including a mixture thereof) is preferably used. This is because lithium stearate or 12-hydroxy lithium stearate improves the flowing property, and its melting point of 220° C. is high so that the softening thereof does not occur. The amount of the flow initiating material to be added is in a range of from 0.002 wt % to 0.1 wt %, and more preferably, from 0.004 wt % to 0.05 wt %, and a grain size (maximum diameter) of the flow initiating material is in a range of from 1 μm to 20 μm, and more preferably, from 1 μm to 10 μm. If the amount of the flow initiating material added is less than 0.002 wt %, sufficient flowing property cannot be obtained, and if the amount added is more that 0.1 wt %, sufficient strength cannot be obtained. If the grain size (maximum diameter) of the flow initiating material is less than 1 μm, the manufacturing thereof is difficult, and if the grain size is more than 20 μm, too much additive amount is needed to obtain the desired flowing property. In this case, sufficient strength cannot be obtained.

Next, the upper punch 21 is inserted into the through hole 19 with a predetermined pressure, so that the core 2 is molded. During the molding, the soft magnetic powder 14 is in contact with the wall surface of the through hole 19 and also in contact with the outer surface of the core pin 22, the surfaces of the upper planes 23a, 24a, and 25a, and the inner and outer surfaces of the second lower punch 24. In the contacts, since the lubricant layer 29 is interposed between the soft magnetic powder 14 and the planes of the receiving portion 28, the soft magnetic powder 14 can be pressed, while benefiting from lubrication, by the female die 20, the upper punch 21, and the first to third lower punches 23, 24, and 25, so that the contact resistance at the planes and surfaces is reduced (see FIG. 4). As a result, the press pressure can reach into an inner portion of the molded body, that is, the pressed body, so that the volume ratio of the soft magnetic powder 14 per unit volume of the molded body can be increased. In addition, since the flow initiating material 17 is interposed between the soft magnetic powder 14 and the receiving portion 28, the press pressure can further reach into the inner portion of the molded body. In addition, the flow initiating material 17 is interposed between the grains of the soft magnetic powder 14 and between the soft magnetic powder 14 and the binder 15, so that the press pressure can further reach into the inner portion of the molded body.

When the warm molding process ends, the upper punch 21 is lifted, and the first to third lower punches 23, 24, and 25 are lifted, so that the molded body (core) is extracted from the through hole 19.

Now, a response characteristic (FIG. 6a) of the core manufactured according to the present invention and a response characteristic (FIG. 6b) of a conventional sintered core are described with reference to FIG. 6. The core according to the present invention has a permeability of μmax=6×10⁻⁴ H/m, a magnetic flux density of B 10 kA/m: 1.67 T, and a resistivity of 500 μΩm.

On the other hand, the sintered core has a permeability of μmax=5×10⁻⁵ H/m, a magnetic flux density of B 10 kA/m: 1.57 T, and a resistivity of 1˜1.5 μΩm. As a result, the magnetic flux density of the core according to the present invention is close to that of iron, and the resistivity thereof is higher by 2 or 3 orders of magnitude than that of a metal material. As shown by the plunger lift duration data in FIGS. 6a and 6b, the response characteristics at operation start and end times of the core according to the present invention are superior to those of the sintered core.

According to the aforementioned embodiment, the polyimide resin having a thermally and chemically stabilized molecular structure is used for the binder 15 for the soft magnetic powder 14, so that it is possible to improve the heat resistance and the chemical resistance in comparison with a conventional core. In addition, the polyimide resin is used for the binder 15, and the ratio of the polyimide resin to the soft magnetic powder 14 is in a range of from 0.05 wt % to 1.0 wt %, so that sufficient resistivity and strength can be obtained. As a result, the molding can be effectively performed. In addition, since the electromagnet 1 provided with the core 2 having an improved heat resistance and chemical resistance is used as a valve control electromagnet of the liquid fuel injector 7 in FIG. 5, the injector attached to an engine can be effectively operated.

In addition, since the lubricant layer 29 formed on surfaces of the through hole 19 and the like of the receiving portion 28 formed in the molding die 18 improves the lubricating property between the soft magnetic powder 14 and the surfaces, friction between the soft magnetic powder 14 and the surfaces of the through hole 19 and the like caused by the press pressure during the molding process can be reduced. As a result, gaps between grains of the soft magnetic powder 14 and between the soft magnetic powder 14 and the binder 15 can be reduced during the molding process. In addition, the lubricant layer 29 is formed by vaporizing the moisture of the coated lubricant solution 29a by using the heat of the receiving portion 28, so that the thickness of the lubricant layer 29 can be reduced and made uniform. The flow initiating material 17 in addition to the soft magnetic powder 14 and the binder 15 is added, so that the flowing property of the mixture during the pressing process and the like can be further improved.

Potential Industrial Usage

An electromagnet core according to the present invention can be used for a measuring valve control electromagnet used for a liquid fuel injector and for other purposes as well.

### BRIEF DESCRIPTION OF THE DRAWINGS

FIG. 1 is a perspective disassembled view showing an electromagnet according to an embodiment of the present invention.

FIG. 2 is a cross-sectional view showing an internal constitution of a core according to an embodiment of the present invention.

FIG. 3 is a cross-sectional view showing a molding apparatus according to an embodiment of the present invention.

FIG. 4 is a cross-sectional view showing an internal constitution during a pressing process according to an embodiment of the present invention.

FIG. 5 is a schematic cross-sectional view showing a partially cut portion of an injector of a liquid fuel injection unit for an engine according to an embodiment of the present invention.

FIG. 6a is a graph showing a response characteristic of a core according to the present invention. The abscissa indicates time.

FIG. 6b is a graph showing a response characteristic of a conventional sintered core. The abscissa indicates time.

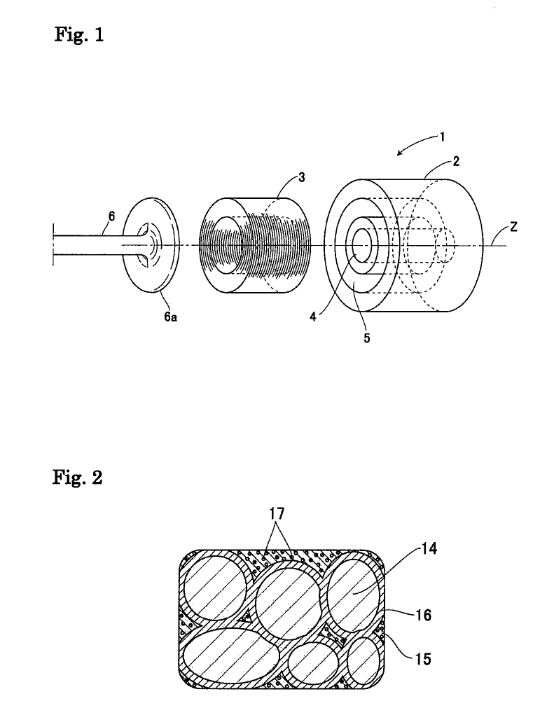

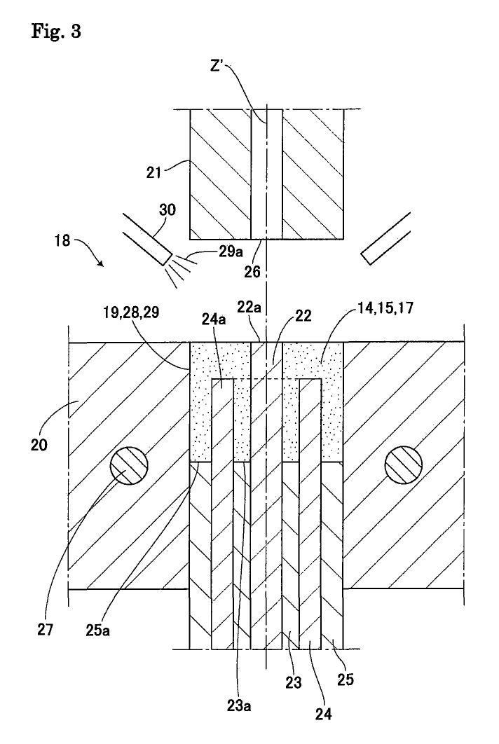

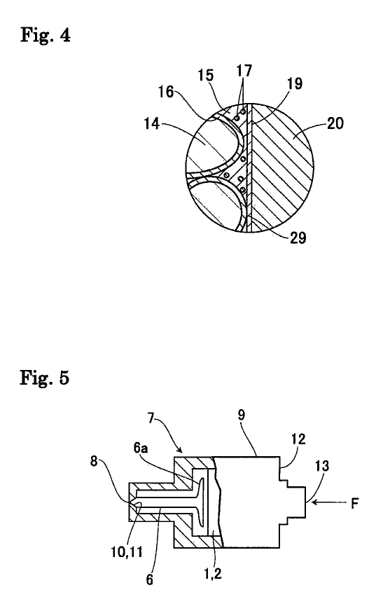

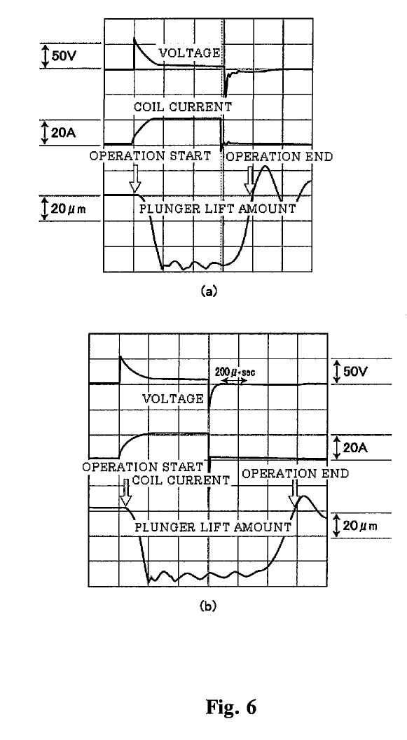

### REFERENCE NUMERALS

2: core

3: coil

7: liquid fuel injector

11: needle-shaped valve

14: magnetic powder

15: binder

17: flowing material

18: molding die

28: receiving portion

29: lubricant layer

29a: lubricant solution

1. An electromagnet core capable of accommodating a coil, the electromagnet core comprising:
a soft magnetic powder; and
a binder made of polyimide resin.

2. The electromagnet core according to claim 1, wherein a volume ratio of the polyimide resin to the soft magnetic powder is in a range of from 0.05 wt % to 1.0 wt %.

3. A measuring valve control electromagnet used for a liquid fuel injector, wherein the measuring valve control electromagnet comprises the electromagnet core according to claim 1.

4. A method of manufacturing an electromagnet core comprising the steps of accommodating a coil, the method comprising steps of:
forming a lubricant layer on a receiving portion of a surface of a frame of a molding die;
placing a mixture of soft magnetic powder and a binder made of polyimide resin into the molding die; and
molding the mixture by using a pressing process.

5. The method according to claim 4, wherein the step of forming a lubricant layer on a receiving portion comprises the steps of:
heating the receiving portion from room temperature to a high temperature;
coating the surface of the receiving portion with a solution containing a lubricant; and
vaporizing the solvent of the lubricant solution by the heat of the receiving portion.

6. The method according to claim 5, the method further comprising the step of adding a flow initiating material to the mixture.

7. A measuring valve control electromagnet used for a liquid fuel injector, the measuring valve control electromagnet comprising the electromagnet core according to claim 2.

8. The method according to claim 5, wherein the solution containing the lubricant is an aqueous solution.

9. The method according to claim 8, the method further comprising the step of adding a flow initiating material to the mixture.

10. The electromagnet core according to claim 1, wherein grains of the soft magnetic powder are coated with an insulating film.

11. The electromagnet core according to claim 1, wherein the soft magnetic powder is made of electromagnetic soft iron or silicon steel.

12. The electromagnet core according to claim 1, wherein grain size of the soft magnetic powder is in a range of from 10 μm to 200 μm.

13. The electromagnet core according to claim 1, wherein grain size of the soft magnetic powder is in a range of from 10 μm to 100 μm.

14. The electromagnet core according to claim 1, wherein the polyimide resin is made of wholly aromatic polyimide, bismaleide polyimide, or additive-type polyimide.

15. The electromagnet core according to claim 1, wherein a ratio of the polyimide resin to the soft magnetic powder is in a range of from 0.1 wt % to 0.5 wt %.

16. The method according to claim 8, wherein the aqueous solution containing the lubricant is an aqueous solution of sodium benzoate or an aqueous solution of potassium dihydrogen phosphate.

17. The method according to claim 9, wherein the flow initiating material is ethylene bis-stearamide, ethylene bis-laurylamide, or methylene bis-stearamide, or a mixture thereof.

18. The method according to claim 9, wherein the flow initiating material is a material formed by adding:
30% or less lithium stearate or 12-hydroxy lithium stearate; to
ethylene bis-stearamide, ethylene bis-laurylamide, or methylene bis-stearamide, or a mixture thereof.

19. The method according to claim 9, wherein the amount of the flow initiating material added to the mixture is in a range of from 0.002 wt % to 0.1 wt %.

20. The method according to claim 9, wherein grain size of the flow initiating material is in a range of from 1 μm to 20 μm.
